(19) United States
(12) Patent Application Publication
(10) Pub. No.: US 2008/0186937 A1
(43) Pub. Date: Aug. 7, 2008

(54) Interlaced complementary code sets based on codes with unity peak sidelobes

(76) Inventors: Adly T. Fam, East Amherst, NY (US); Indranil Sarkar, North Tonawanda, NY (US)

Correspondence Address: ADLY T. FAM, 1206 CHARLESGATE CIR., EAST AMHERST, NY, 14051-1215, US

(21) Appl. No.: 11/672,203

(22) Filed: Feb. 7, 2007

(51) Int. Cl. H04J 4/00; H04L 27/00

(52) U.S. Cl. 370/343; 375/259

(57) ABSTRACT

A new class of biphase complementary code sets is proposed. Individual codes in each set have peak sidelobes of unity magnitude. The individual codes could have gaps of zeros but they are interlaced together without gaps in the final scheme. A number of such codes, as introduced here, use Barker codes as building blocks with additional elements from {+1,−1,0}. The main drawback of regular complementary codes longer than 4 is that they have sidelobe magnitude greater than unity. In the presence of frequency selective fading, inexact sidelobe cancellation results in non-zero sidelobes at the output. These sidelobes are minimized by using sets with individual codes that have peak sidelobes of unity magnitude. The constituent codes are transmitted at different frequencies. They are transmitted in parallel or using an appropriate combination of frequency division multiplexing (FDM) and time division multiplexing (TDM) such that the final transmission scheme is free of gaps.

### FIELD OF THE INVENTION

The invention relates to radar and sonar systems, wireless communication systems and other systems using complementary codes.

### BACKGROUND OF THE INVENTION

Complementary codes or sequences were introduced by Golay for use in radar astronomy. A complementary set is a set of finite sequences whose autocorrelation functions, when added together, cancel out the sidelobes of each other. Any complementary set can be used to generate longer ones. The root sequences which are defined directly and not generated from shorter ones, are also referred to as kernels. Golay came up with kernels of binary complementary pairs of length 2, 10 and 26. This is found in: M. J. E. Golay, Complementary series, IRE Transactions on Information Theory, Vol IT-7, April 1961, pp. 82-87.

Sivaswamy proposed polyphase complementary sequences and gave kernels of complementary triplets of length 2 and 3. This work is found in: R. Sivaswamy, Multiphase complementary codes, IEEE Transactions on Information Theory, Vol IT-24, No. 5, March 1973, pp 214-218.

Additional polyphase codes, and their related kernels, based on the discrete Fourier transform (DFT) are introduced in: R. L. Frank, Polyphase complementary codes, IEEE Transactions on Information Theory, Vol IT-26, no. 6, October 1980, pp. 641-647.

Biphase and polyphase complementary codes are attractive in radar applications because they can achieve zero sidelobes. However, in the presence of frequency selective fading, unequal fading of the individual codes prevents exact cancellation of their sidelobes, thus degrading their performance. Hence, a logical prerequisite for a good complementary set is that the sidelobes of the individual codes be as small as possible. This is satisfied by the new class of Interlaced Complementary Codes (ICC) introduced next.

Let us consider the class of codes that are constructed from the alphabet [symbol] ={+1, −1, 0} and have peak sidelobes of unity magnitude. We denote this class by [symbol] The constituent codes of the ICC are members of [symbol] Let {tₙ} be a code of length N in [symbol] Its aperiodic autocorrelation function (ACF) is given by:

$${A}_{t} ( τ ) = {\sum }_{n = 0}^{N - τ - 1} {t}_{n} {t}_{n + τ} \qquad ( 1 )$$

where 0≦τ≦N−1.
The peak sidelobe constraint on the members of [symbol] specifies that:

$${max}_{τ \neq 0} \vert {A}_{t} ( τ ) \vert = 1 \qquad ( 2 )$$

Barker codes are the only biphase codes that satisfy (2). Let the class of Barker codes be [symbol] Obviously, [symbol] ⊂ [symbol] The constituent codes in the proposed ICC may contain Barker codes or Barker codes modified with additional elements from [symbol] . In this work, we present several schemes involving two or more codes from [symbol] that form complementary sets.

All constituent codes are transmitted at different frequencies and those with gaps of zeros are properly interlaced to result in a final scheme free of gaps. The final scheme could be purely time division multiplexed (TDM) or allow some amount of parallel transmission depending on the structure of the constituent codes. If the purely TDM scheme can be broken down into equal length blocks in a way such that each constituent code is contained only in one particular block, then these equal length blocks can be transmitted simultaneously. This gives rise to a hybrid transmission scheme using both TDM and simultaneous transmission. The advantages of TDM are low peak to average power ratio resulting in a low probability of interception. In addition, only one transmitter with frequency hopping capabilities is required. However, using TDM alone results in longer codes that are more susceptible to multipath and eclipsing problems. The parallel transmission scheme results in shorter codes and hence is better suited to counter eclipsing and multipath problems. These come at the cost of a higher peak to average power ratio, higher detectability and increased number of transmitters or a wider band transmitter with higher power output. A hybrid scheme achieves a trade-off between these two transmission modalities. However, special attention has to be paid to carefully select the modulation schemes to optimize the parameters mentioned above. Orthogonal frequency division multiplexing (OFDM) techniques could be used with judiciously selected frequencies to enhance the performance of the overall system, in particular to reduce peak to average power ratio. An example of such a scheme is discussed in: N. Levanon, Multifrequency complementary phase-coded radar signal, IEE Proceedings on Radar, Sonar and Navigation, Vol 147, No. 6, pp. 276-284.

We introduce several examples of the proposed Interlaced Complementary Codes (ICC). As mentioned before, the constituent codes of the ICC's are constructed from [symbol] and hence may contain zeros. However, the final transmission scheme is free of zeros and contains only elements from {−1, +1}. In these examples, we use Barker codes as building blocks with additional elements from [symbol] to obtain the constituent codes belonging to [symbol] However, using Barker codes is not a necessary condition for constructing codes belonging to [symbol] and consequently, the class of ICC. Let the z-transform of a Barker code of length N be denoted by B_{N}(z). If (k−1) zeros are placed between every two elements of the code, then the modified code is represented by B_{N}(z^{k}). The ACF of B_{N}(z) is given by:

R_{N}(z)=B_{N}(z)B_{N}(z⁻¹) (3)

from which we get:

R_{N}(z^{k})=B_{N}(z^{k})B_{N}(z^{-k}) (4)

The following steps are involved in the construction of valid interlaced codes free of any gaps. The challenge is to have the individual codes with unity peak sidelobes fit together such that the final scheme is composed of {+1, −1} without any gaps of zeros.
Two or more constituent codes should be chosen from [symbol] such that their sidelobes cancel out when the ACF's are added together.
Constituent codes with gaps are interlaced with each other such that there are no gaps in the final transmission scheme. The constituent codes may have to be delayed with respect to each other so that they fit together without any gaps. Correspondingly, appropriate delays would also be needed at the receiver end for each constituent code, so that the ACF's (or the output of the matched filters) are aligned properly before addition.
Each constituent code is transmitted at a different frequency. The number of frequencies used is therefore equal to the number of constituent codes.

### BRIEF DESCRIPTION OF THE DRAWINGS

FIG. 1 is a diagram illustrating the autocorrelation of length 13 Barker code.

FIG. 2 is a diagram illustrating the autocorrelation of length 11 Barker code.

FIG. 3 is a diagram illustrating the autocorrelation of the modified length 2 Barker code.

FIG. 4 is a diagram illustrating the autocorrelation of the modified length 7 Barker code.

FIG. 5 is a diagram illustrating the autocorrelation of the modified length 5 Barker code.

### DETAILED DESCRIPTION OF THE INVENTION

ICC set I Involving B₁₃(z), B₁₁(z) and B₂(z¹²)

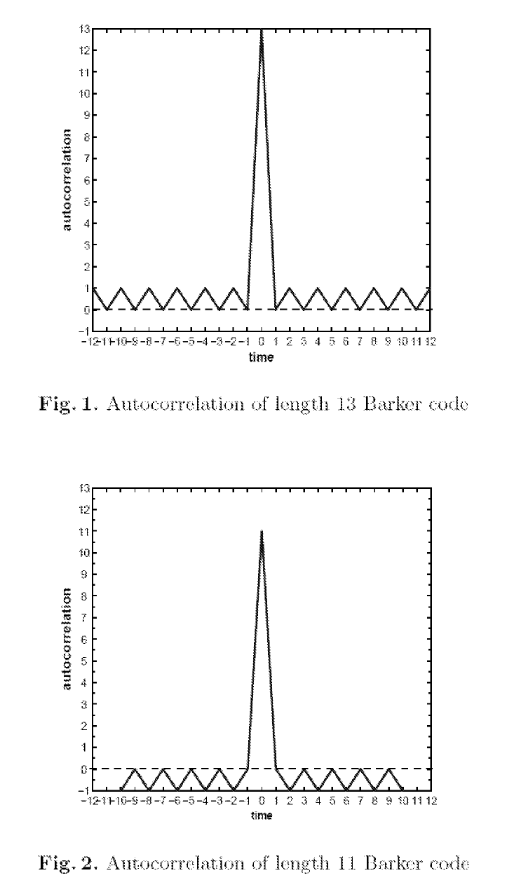

The autocorrelation function R₁₃(z) of the Barker code of length 13 is shown in FIG. 1. It can be seen that on each side of the mainlobe, there are 12 sidelobes of alternating +1's and 0's.

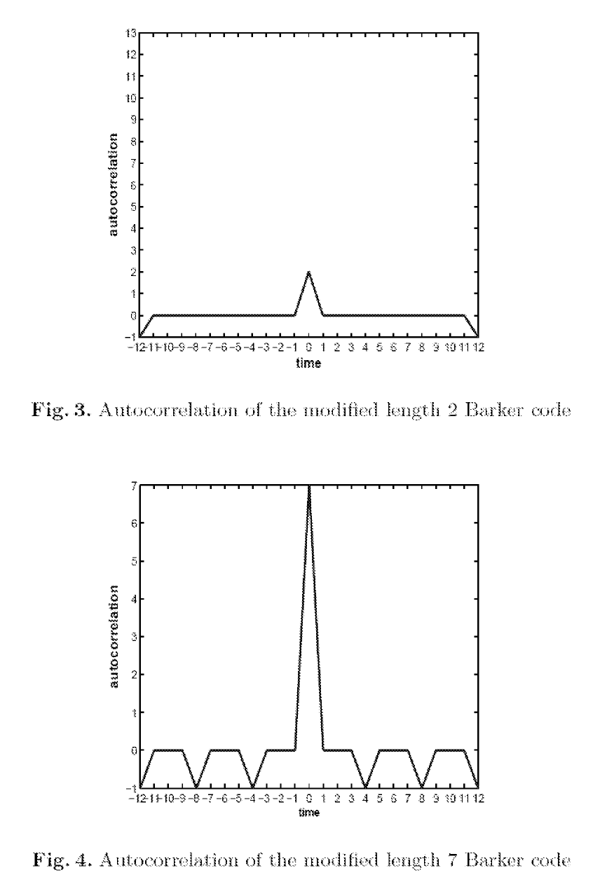

The autocorrelation function R₁₁ (z) for the Barker code of length 11 is shown in FIG. 2. R₁₁(z) has 10 sidelobes on each side of the mainlobe of alternating −1's and 0's. Furthermore, it can also be observed that when they are aligned, −1 sidelobes of R₁₁(z) coincides exactly with +1 sidelobes of R₁₃(z). Thus, when added together, the sidelobes cancel out with the exception of one sidelobe each at either end of R₁₃(z). We also note that the Barker code of length 2, {1,−1}, produces two sidelobes of height −1. The code of length 2, with 11 zeros inserted between its two elements, is represented by B₂(z¹²). The corresponding autocorrelation function R₂(z¹²) can be used to cancel out the two remaining sidelobes of R₁₃(z) that R₁ (z) did not cancel. R₂(z¹²) is shown in FIG. 3.

TABLE 1
Transmission scheme for ICC-I

| | t₁ | t₂ | t₃ | t₄ | t₅ | t₆ | t₇ | t₈ | t₉ | t₁₀ | t₁₁ | t₁₂ | t₁₃ | t₁₄ | t₁₅ | t₁₆ | t₁₇ | t₁₈ | t₁₉ | t₂₀ | t₂₁ | t₂₂ | t₂₃ | t₂₄ | t₂₅ | t₂₆ |
|---|---|---|---|---|---|---|---|---|---|---|---|---|---|---|---|---|---|---|---|---|---|---|---|---|---|---|
| f₁ | −1 | −1 | −1 | −1 | −1 | 1 | 1 | −1 | −1 | 1 | −1 | 1 | −1 | 0 | 0 | 0 | 0 | 0 | 0 | 0 | 0 | 0 | 0 | 0 | 0 | 0 |
| f₂ | 0 | 0 | 0 | 0 | 0 | 0 | 0 | 0 | 0 | 0 | 0 | 0 | 0 | 1 | 0 | 0 | 0 | 0 | 0 | 0 | 0 | 0 | 0 | 0 | 0 | −1 |
| f₃ | 0 | 0 | 0 | 0 | 0 | 0 | 0 | 0 | 0 | 0 | 0 | 0 | 0 | 0 | −1 | −1 | −1 | 1 | 1 | 1 | −1 | 1 | 1 | −1 | 1 | 0 |

TABLE 2
Hybrid transmission scheme for ICC-I

| | t₁ | t₂ | t₃ | t₄ | t₅ | t₆ | t₇ | t₈ | t₉ | t₁₀ | t₁₁ | t₁₂ | t₁₃ |
|---|---|---|---|---|---|---|---|---|---|---|---|---|---|
| f₁ | −1 | −1 | −1 | −1 | −1 | 1 | 1 | −1 | −1 | 1 | −1 | 1 | −1 |
| f₂ | 1 | 0 | 0 | 0 | 0 | 0 | 0 | 0 | 0 | 0 | 0 | 0 | −1 |
| f₃ | 0 | −1 | −1 | −1 | 1 | 1 | 1 | −1 | 1 | 1 | −1 | 1 | 0 |

It is easy to see that the transmission scheme should be such that the 11 gaps between the elements of B₂(z¹²) should be filled by code bits from some other code so that the final transmission scheme is free of gaps. We also observe that these gaps could be filled by placing B₁₁(z) as it is in these gaps. The transmission scheme is therefore given by:

T(z)=B₁₃(z)+z⁻¹³B₂(z¹²)+z⁻¹⁴B₁₁(z) (5)

Thus, in this transmission scheme B₁₃(z) is transmitted first. The first bit of B₂(z) is transmitted next followed by the entire B₁₁(z). Finally the remaining bit of B₂(z¹²) is transmitted resulting in transmission of all the codes in an interlaced fashion and free of any gaps.

Table I depicts the transmission scheme graphically. The columns t₁-t₂₆ depict the time slots whereas f₁-f₃ depict the three different frequencies used to modulate B₁₃(z), B₂(z¹²) and B₁₁(z), respectively. Since no gaps (or 0's) are allowed in the transmission scheme and only one code bit can be transmitted in a given time slot, each column in the table should have only a single 1 or −1. Also, no columns can have all 0's. Similar tables can be constructed for all the transmission schemes described in this paper.

There are some obvious alternative schemes to the one mentioned above. Each of the B₁₃(z), B₁₁(z) and B₂(z¹²) as well as the entire transmission scheme can be flipped to produce 16 obvious alternative schemes. It is also to be noted that B₁₃(z) comprises the first 13 bits of the scheme. The combination of B₁₁ (z) and B₂(z¹²) comprise the remaining 13 bits. Hence, B₁₃(z) and the combination of B₁₁(z) and B₂(z¹²) can be transmitted simultaneously to reduce the overall length of the complementary code. This transmission scheme contains both simultaneous and TDM transmissions. This hybrid scheme is depicted in Table II. The parallel components for this case are given as:

T_{P1}(z)=B₁₃(z) (6)

T_{P2}(z)=B₂(z¹²)+z⁻¹B₁₁(z) (7)

All ICC sets are constructed in a way that they can always be transmitted in a sequential bit by bit fashion. However, some amount of parallel transmission is possible in certain code sets depending on their structure. ICC set I is an example of such a code.

ICC Set II Involving B₁₃(z²), B₁₁(z²) and B₂(z²⁴)

If we put one gap in between the elements of B₁₃(z) and B₁₁(z), we come up with two modified Barker codes B₁₃(z²) and B₁₁(z²), respectively. The corresponding autocorrelation functions are now R₁₃(z²) and R₁₁(z²), respectively. When lined up with one another, all the sidelobes will cancel each other except the ones at the extreme ends of R₁₃(z²). We note that in this case, we will require R₂(z²⁴) to cancel these two remaining sidelobes. Hence, we need to transmit B₂(z²⁴) in the transmission scheme.

In the transmission scheme, 11 of the 12 gaps created in B₁₃(z²) are filled by the elements of B₁₁ (z²). The one remaining gap just before the last element of B₁₃(z²) needs to be filled somehow using the code bits of B₂(z²⁴). We observe that if we place the first bit of B₂(z²⁴) just before the first element of B₁₃(z²), the last bit of B₂(z²⁴) occupies the gap to be filled. Thus, the gap-free transmission scheme is given by:

T(z)=B₂(z²⁴)+z⁻¹B₁₃(z²)+z⁻²B₁₁(z²) (8)

TABLE 3
Transmission scheme for ICC-II

| | t₁ | t₂ | t₃ | t₄ | t₅ | t₆ | t₇ | t₈ | t₉ | t₁₀ | t₁₁ | t₁₂ | t₁₃ | t₁₄ | t₁₅ | t₁₆ | t₁₇ | t₁₈ | t₁₉ | t₂₀ | t₂₁ | t₂₂ | t₂₃ | t₂₄ | t₂₅ | t₂₆ |
|---|---|---|---|---|---|---|---|---|---|---|---|---|---|---|---|---|---|---|---|---|---|---|---|---|---|---|
| f₁ | 1 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | −1 | 0 |
| f₂ | 0 | −1 | 0 | −1 | 0 | −1 | 0 | −1 | 0 | −1 | 0 | 1 | 0 | 1 | 0 | −1 | 0 | −1 | 0 | 1 | 0 | −1 | 0 | 1 | 0 | −1 |
| f₃ | 0 | 0 | −1 | 0 | −1 | 0 | −1 | 0 | 1 | 0 | 1 | 0 | 1 | 0 | −1 | 0 | 1 | 0 | 1 | 0 | −1 | 0 | 1 | 0 | 0 | 0 |

Table III shows the graphical representation of the transmission scheme. Once again, t₁-t₂₆ represent the time slots and f₁-f₃ represent the frequencies used to modulate B₂(z²⁴), B₁₃(z²) and B₁₁(z²), respectively. Once again, reversal of the transmission order of the individual codes or the entire scheme produce several equivalent ICC sets. Unlike the ICC set I, simultaneous transmission is not possible for this set since the purely TDM scheme shown in table III cannot be divided into equal length blocks containing complete constituent codes.

ICC Set III Involving B₁₃(z), B₁₁(z), B₇(z²) and B₅(z²)

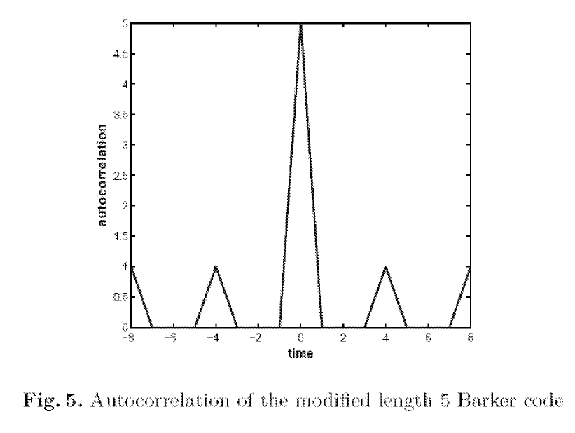

This set is based on Barker codes of length 13, 11, 7 and 5. We have shown the autocorrelation functions of the length 13 and length 11 codes in FIGS. 2 and 3, respectively. When these two autocorrelation functions R₁₃(z) and R₁₁(z) are added together, the sidelobes cancel each other out except the two positive sidelobes at the two extremes of R₁₃(z). In this set, we seek to cancel out this sidelobe with the autocorrelation function of suitably modified length 7 Barker code. We insert a zero between each element of the length 7 Barker code. In other words we use B₇(z²). The corresponding autocorrelation function R₇(z²) is shown in FIG. 4.

This autocorrelation function, R₇ (z²), cancels the two residual sidelobes of R₁₃ (z), but introduces two new negative sidelobes. We observe that these sidelobes can easily be cancelled out by the autocorrelation function of the length 5 Barker code when one zero is inserted between each of its elements. Using similar notations as before, this modified length 5 Barker code is represented as B₅(z²) and its autocorrelation function R₅(z²) is shown in FIG. 5.

When these autocorrelation functions, i.e. R₁₃(z), R₁ (z), R₇(z²) and R₅(z²) are summed together, The sidelobes cancel each other out and we get a mainlobe of height 72. Next, we propose a time division multiplexed and interlaced scheme for the transmission of this code set.

For this code set, we transmit B₁₃(z) and B₁₁(z) back to back. Then we send B₇(z²) and B₅(z²) interlaced with each other. We observe that this results in a gap just before the last bit. To avoid the gap, we flip this entire transmission scheme and the first bit of the flipped scheme is made to occupy the aforementioned gap. The final transmission scheme is given by:

$$T ( z ) = {B}_{13} ( z ) + {z}^{- 13} {B}_{11} ( z ) + {z}^{- 24} {B}_{7} ( {z}^{2} ) + {z}^{- 25} {B}_{5} ( {z}^{2} ) + {z}^{- 35} {B}_{7} ( {z}^{2} ) + {z}^{- 38} {B}_{5} ( {z}^{2} ) + {z}^{- 48} {B}_{11} ( z ) + {z}^{- 59} {B}_{13} ( z ) \qquad ( 9 )$$

The long code that results can be shortened significantly by using the hybrid transmission schemes. We observe that the TDM transmission scheme given by (9) can be broken into 3 parallel components each of length 24. The parallel components are given by:

T_{P1}(z)=B₁₃(z)+z⁻¹³B₁₁(z) (10)

$${T}_{P 2} ( z ) = {z}^{- 24} {B}_{7} ( {z}^{2} ) + {z}^{- 1} {B}_{5} ( {z}^{2} ) + {z}^{- 11} {B}_{7} ( {z}^{2} ) + {z}^{- 14} {B}_{5} ( {z}^{2} ) \qquad ( 11 )$$

T_{P3}(z)=B₁₃(z)+z⁻¹³B₁₁(z) (12)

The hybrid simultaneous and TDM transmission scheme is shown in table IV.

TABLE 4
Hybrid transmission scheme for ICC-III

| | t₁ | t₂ | t₃ | t₄ | t₅ | t₆ | t₇ | t₈ | t₉ | t₁₀ | t₁₁ | t₁₂ | t₁₃ | t₁₄ | t₁₅ | t₁₆ | t₁₇ | t₁₈ | t₁₉ | t₂₀ | t₂₁ | t₂₂ | t₂₃ | t₂₄ |
|---|---|---|---|---|---|---|---|---|---|---|---|---|---|---|---|---|---|---|---|---|---|---|---|---|
| f₁ | −1 | −1 | −1 | −1 | −1 | 1 | 1 | −1 | −1 | 1 | −1 | 1 | −1 | 0 | 0 | 0 | 0 | 0 | 0 | 0 | 0 | 0 | 0 | 0 |
| f₂ | 0 | 0 | 0 | 0 | 0 | 0 | 0 | 0 | 0 | 0 | 0 | 0 | 0 | −1 | −1 | −1 | 1 | 1 | 1 | −1 | 1 | 1 | −1 | 1 |
| f₃ | −1 | 0 | −1 | 0 | −1 | 0 | 1 | 0 | 1 | 0 | −1 | 0 | 1 | 0 | 0 | 0 | 0 | 0 | 0 | 0 | 0 | 0 | 0 | 0 |
| f₄ | 0 | −1 | 0 | −1 | 0 | −1 | 0 | 1 | 0 | −1 | 0 | 0 | 0 | 0 | 0 | 0 | 0 | 0 | 0 | 0 | 0 | 0 | 0 | 0 |
| f₅ | 0 | 0 | 0 | 0 | 0 | 0 | 0 | 0 | 0 | 0 | 0 | −1 | 0 | −1 | 0 | −1 | 0 | 1 | 0 | 1 | 0 | −1 | 0 | 1 |
| f₆ | 0 | 0 | 0 | 0 | 0 | 0 | 0 | 0 | 0 | 0 | 0 | 0 | 0 | 0 | −1 | 0 | −1 | 0 | −1 | 0 | 1 | 0 | −1 | 0 |
| f₇ | −1 | −1 | −1 | −1 | −1 | 1 | 1 | −1 | −1 | 1 | −1 | 1 | −1 | 0 | 0 | 0 | 0 | 0 | 0 | 0 | 0 | 0 | 0 | 0 |
| f₈ | 0 | 0 | 0 | 0 | 0 | 0 | 0 | 0 | 0 | 0 | 0 | 0 | 0 | −1 | −1 | −1 | 1 | 1 | 1 | −1 | 1 | 1 | −1 | 1 |

### ICC Set IV Involving Modified B₁₃(z), B₁₁(z) and B₂(z)

In this set, we start with a Barker code of length 13. In the time domain the Barker code B_{N}(Z) is denoted as b_{N}(n). It should be noted that the time reversed or flipped version of this code is denoted by b_{N}(N−n) while the corresponding z-transform is given by z^{-N}B_{N}(z⁻¹). Starting with b₁₃(n) and appending a 1 and thirteen 0's at the beginning, the first constituent code is constructed as:

$${c}_{1} ( n ) = [ 1 \underbrace{0 \; 0 ⋯ 0}_{13} {b}_{13} ( n ) ] \qquad ( 13 )$$

Next, the Barker code of length 13 is flipped and thirteen 0's and a −1 are appended at the end. Thus, the second constituent code looks like:

$${c}_{2} ( n ) = [ {b}_{13} ( 13 - n ) \underbrace{0 \; 0 ⋯ 0}_{13} - 1 ] \qquad ( 14 )$$

It is easy to see that c₁(n) and c₂(n) will interlace with each other with the b₁₃(13−n) of c₂(n) occupying the positions of the thirteen 0's in c₁(n). To counter the sidelobes due to these two codes, we employ the Barker codes of lengths 11 and 2 using each of them twice. The length 2 and length 3 codes are modified to produce the following constituent codes:

$$\begin{matrix}{c}_{3} ( n ) = [ 1 \underbrace{0 \; 0 ⋯ 0}_{14} {b}_{11} ( n ) ] & ( 15 ) \\ {c}_{4} ( n ) = [ {b}_{11} ( 11 - n ) \underbrace{0 \; 0 ⋯ 0}_{14} - 1 ] & ( 16 ) \\ {c}_{5} ( n ) = {c}_{6} ( n ) = [ 1 \underbrace{0 \; 0 ⋯ 0}_{11} - 1 ] & ( 17 )\end{matrix}$$

which corresponds to:

C₅(z)=C₆(z)=B₂(z¹²) (18)

Also, cᵢ(n)ε [symbol] ∀i. The autocorrelation functions produced by c₃(n), c₄(n), c₅(n) and c₆(n) cancel out the sidelobes due to c₁(n) and c₂(n). All these codes can be interlaced with each other perfectly and the transmission scheme in the z-domain notations is given as:

$$T ( z ) = {C}_{1} ( z ) + {z}^{- 1} {C}_{2} ( z ) + {z}^{- 28} {C}_{3} ( z ) + {z}^{- 30} {C}_{4} ( z ) + {z}^{- 29} {C}_{5} ( z ) + {z}^{- 42} {C}_{6} ( z ) \qquad ( 19 )$$

This ICC set uses six different frequencies to produce a mainlobe of height 56. A parallel scheme is also possible for this scheme apart from the sequential scheme described by equation (19). The combination of c₁(n) and c₂(n) is completely contained in the first 28 bits of the sequential transmission scheme. On the other hand the combination of c₃(n), c₄(n), c₅(n) and c₆(n) is completely contained in the remaining 28 bits of sequential transmission scheme. Hence, the two combination schemes can be transmitted in parallel.

### ICC Set V Obtained by Modifying Set III

Some ICC sets could be modified to obtain higher mainlobes using the same number of frequencies. Consider the Barker code of length n. If we add to it a 1 or −1 before or after n or more zeros, the resultant autocorrelation function will still have unity peak sidelobe. Hence, if a code contains two copies of any code block of length N from [symbol] , the following trick can be applied to enhance the mainlobe further.
Add a 1 before at least (N−1) zeros preceding one of the code blocks thus yielding:

$${c}_{1} ( n ) = [ 1 \underbrace{0 \; 0 ⋯ 0}_{\geq ( N - 1 )} {b}_{N} ( n ) ] \qquad ( 20 )$$

Add a −1 before at least N−1 zeros preceding the other code and flip the final product. This gives:

$${c}_{2} ( n ) = [ {b}_{N} ( N - n ) \underbrace{0 \; 0 ⋯ 0}_{\geq ( N - 1 )} - 1 ] \qquad ( 21 )$$

The insertion of 1's and −1's should be done only if it is possible to accommodate them in a scheme without gaps.

Equations (13)-(16) makes use of this concept. In this example we extend the concept to ICC set III to show how the mainlobe can be enhanced further without using more frequencies. The constituent codes for these sets are formed as follows:

$$\begin{matrix}{c}_{1} ( n ) = [ 1 \underbrace{0 \; 0 ⋯ 0}_{64} {b}_{13} ( n ) ] & ( 22 ) \\ {c}_{2} ( n ) = [ {b}_{13} ( 13 - n ) \underbrace{0 \; 0 ⋯ 0}_{64} - 1 ] & ( 23 ) \\ {c}_{3} ( n ) = [ 1 \underbrace{0 \; 0 ⋯ 0}_{13} {b}_{11} ( n ) ] & ( 24 ) \\ {c}_{4} ( n ) = [ {b}_{11} ( 11 - n ) \underbrace{0 \; 0 ⋯ 0}_{13} - 1 ] & ( 25 ) \\ {c}_{5} ( n ) = [ 1 \underbrace{0 \; 0 ⋯ 0}_{14} {b}_{5} ( n ↑ 2 ) ] & ( 26 )\end{matrix}$$

where b_{N}(n↑m) is a modified version of b_{N}(n) having (m−1) zeros between every two successive bits.

$$\begin{matrix}{c}_{6} ( n ) = [ {b}_{5} ( 5 - n ) \underbrace{0 \; 0 ⋯ 0}_{14} - 1 ] & ( 27 ) \\ {c}_{7} ( n ) = [ 1 \underbrace{0 \; 0 ⋯ 0}_{12} {b}_{7} ( n ↑ 2 ) ] & ( 28 ) \\ {c}_{8} ( n ) = [ {\hat{b}}_{7} ( 13 - n ) \underbrace{0 \; 0 ⋯ 0}_{12} - 1 ] & ( 29 )\end{matrix}$$

It can be shown that these codes could be interlaced with each other yielding a gap-free transmission scheme which in the z-domain notations, is given by:

$$T ( z ) = {C}_{1} ( z ) + {z}^{- 1} {C}_{3} ( z ) + {z}^{- 2} {C}_{2} ( z ) + {z}^{- 26} {C}_{7} ( z ) + {z}^{- 27} {C}_{5} ( z ) + {Z}^{- 28} {C}_{8} ( z ) + {z}^{- 29} {C}_{6} ( z ) + {z}^{- 54} {C}_{4} ( z ) \qquad ( 30 )$$

Using this ICC set, we can achieve a mainlobe height of 80 using the same 8 frequencies used in ICC set III.

### Frequency Diversity Efficiency

We define the frequency diversity efficiency (FDE) as the ratio of the height of the mainlobe Hₘ and the number of frequencies N_{f}. The FDE is given by:

$$η = \frac{{H}_{m}}{{N}_{f}} \qquad ( 31 )$$

TABLE 5
FDE for the proposed schemes

| Scheme | I | II | III | IV | V |
|---|---|---|---|---|---|
| Hₘ | 26 | 26 | 72 | 56 | 80 |
| N_{f} | 3 | 3 | 8 | 6 | 8 |
| η | 8.67 | 8.67 | 9 | 9.33 | 10 |

The FDE for the different schemes proposed in this paper are summarized in table 5. Iterative application of the idea mentioned for ICC set V would result in higher η provided it could be done without gaps. Let S_{N}={C_{N}} be the set of all ICC codes of length N. Let η_{N} be the maximum η achieved by any code in S_{N}. It is our conjecture that:

$${lim}_{N \to ∞} {\hat{η}}_{N} = ∞ \qquad ( 32 )$$

It is an important topic of further research to prove or disprove this conjecture. Also, given a certain number of frequencies, it is important to find the maximum achievable η or equivalently, the maximum N possible with the given number of frequencies. These open questions are of both theoretical and practical significance.

Comparison with Orthogonal Matrix Codes

Similar to complementary codes, orthogonal matrices could be used to generate codes with zero sidelobes. This could be done either with biphase elements or polyphase elements as in the DFT matrix. The case for biphase elements has been discussed in the publication: F. F. Kretschemer, Jr. and K. Gerlach, “Low sidelobe radar waveforms derived from orthogonal matrices, “IEEE Trans. Aerospace and Electronics Systems,” vol. 27, No. 1, pp. 92-101, January, 1991. The polyphase case of the DFT matrix has been described in:R. L. Frank, “Polyphase complementary codes,” IEEE Trans. Inform. Theory,” vol. IT-26, no. 6, pp. 641-647, October 1980.

In such cases, the matrix elements of a N×N matrix are transmitted row-wise using N frequencies resulting in a mainlobe of N². The conjugate transpose or the Hermitian of the transmitted matrix forms its matched filter in such cases. This approach is more susceptible to frequency selective fading effects since each inner-product contribution to the output is affected by all frequencies. It is also more vulnerable to jamming at any of the frequencies. The codes proposed in this paper results in more graceful degradation in the presence of fading and jamming effects since each element code has unity peak sidelobe and depends only on one frequency. If only one frequency survives, the ICC will still have a code with unity peak sidelobe, while orthogonal matrix codes will could result in much higher sidelobes.

Also, since coherence is easier to maintain at each frequency but more difficult to maintain simultaneously at all frequencies, the ICC codes are more resistant to partial loss in coherence. The 5 examples of ICC sets in this paper have larger η's than the nearest matrix codes greater or equal in length.

What is claimed is:

1. Several novel schemes of interlaced complementary code (ICC) sets. The constituent codes are composed of {1+1,−1,0} and have peak sidelobe of unity. The gaps of zeros in the constituent codes are eliminated in the final schemes when they are interlaced in time.

2. Transmitting and receiving systems for the ICC sets mentioned in claim 1. The system uses a different frequency for each constituent code. The constituent codes are transmitted in parallel or using an appropriate combination of frequency division multiplexing (FDM) and time division multiplexing (TDM) such that the final transmission scheme is free of gaps.
